(19) United States
(12) Patent Application Publication
(10) Pub. No.: US 2005/0052831 A1
(43) Pub. Date: Mar. 10, 2005

(54) Lift-back tablet computer background of the invention

(75) Inventor: Hsiang Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/656,295

(22) Filed: Sep. 8, 2003

(51) Int. Cl. G06F 1/16

(52) U.S. Cl. 361/680

(57) ABSTRACT

A lift-back tablet computer comprises a main system with a back cover, the back cover can turn outward to a proper angle with the main system to form a standing support, and thus the tablet computer is in a standing state. A container is formed on the other side of the main system on the back of the back cover; the container accommodates a hidden keyboard, and users can adjust the hidden keyboard by using a hinge as an axis to turn the hidden keyboard outward to the same side of the touch screen until the hidden keyboard is in a horizontally balanced position, so that users can use the hidden keyboard as a device for entering data. Further, users also can store the hidden keyboard into the container of the back cover on the other side of the main system, and the tablet computer is in a board shape, which is easy to carry and store.

### I. FIELD OF THE INVENTION

This invention relates generally to a tablet computer and, more specifically, to a lift-back tablet computer.

### II. DESCRIPTION OF THE PRIOR ART

Heretofore, it is known that information technologies in the modern world advance rapidly, all computer related high-tech products and mobile communication peripherals roll out fast, and all these products shorten people's distance not only in time but also in space, we cannot do things efficiently without them in our daily life. Along with all new products, especially the tablet computers are getting more and more popular, people's desire for tablet computer also gets higher and higher, and the convenient and effective service of tablet computers becomes an index of indicating the leading position of the manufacturing technology.

Portable computers at early days were not light; they usually weighed about 7 to 14 kg, and notebook computers weighed from 1 to 4 kg. The trend of current tablet computers' design gets lighter, thinner, shorter and smaller, all-in-one design is a major direction, all-in-one computer becomes another name of portable computer. The competition in the current tablet computer market is very severe; there are many brands in the market place, and the sale of tablet computers becomes a great pressure to all computer companies; as to the consumers, it definitely offers more choices for a humanistic tablet computer with desirable functions and reasonable prices; as to computer manufacturers, the multi-functional all-in-one computer becomes the key factor to success in the severe competition of the information market.

A tablet computer, as its name suggests, could be carried and operated exactly like a complete plat panel notebook computer, and it comprises a main system with a touch screen thereon, such that users can control the system through the touch screen. In the meantime, the main system can data to the touch screen display through a communication line, the window on the touch screen display shows the related content of the data.

However, a tablet computer does not come with a keyboard, and users can enter data by a finger or a pen only. The tablet computer does not provide an alternative way of entering data by a regular keyboard, and thus usually making the data input very inconvenient to users. Although a rotary axis tablet computer comes with a keyboard, the complex mechanism of such keyboard is very complicated, not only increasing the cost, but also causing the axis to be loosened or damaged after the rotation and starting for a long time.

Therefore, there are many limitations on its application. If a simple and convenient way of entering data is provided to the tablet computer as an alternative method, it will enhance the utility of the tablet computer to meet the severe competition of the information market. Such arrangement is definitely a big leap and breakthrough on the design for the benefits of our society.

### SUMMARY OF THE INVENTION

It is therefore a primary object of the invention to provide a lift-back tablet computer that is simple in structure for lighter, thinner, shorter and smaller design to overcome the problems of easily loosening and damaging the prior-art tablet computers.

In order to achieve the foregoing objective, a lift-back tablet computer in accordance with the present invention comprises a main system with a back cover, the back cover can turn outward to a proper angle with the main system to form a standing support, and thus the tablet computer is in a standing state. A container is formed on the other side of the main system on the back of the back cover; the container accommodates a hidden keyboard, and users can adjust the hidden keyboard by using a hinge as an axis to turn the keyboard outward to the same side of the touch screen until the keyboard is kept in a horizontally balanced position, so that users can use the hidden keyboard as a device for entering data. Further, users also can store the hidden keyboard into the container of the back cover on the other side of the main system, and the tablet computer is in a board shape, which is easy to carry and store.

### BRIEF DESCRIPTION OF THE DRAWINGS

The accomplishment of the above-mentioned object of the present invention will become apparent from the following description and its accompanying drawings which disclose an illustrative embodiment of the present invention as follows:

FIG. 1 is a perspective view of the present invention;

FIG. 2 is another perspective view of the present invention;

FIG. 3 is an assembly view of the present invention;

FIG. 4 is a cross-sectional of the present invention.

### DESCRIPTION OF THE PREFERRED EMBODIMENT

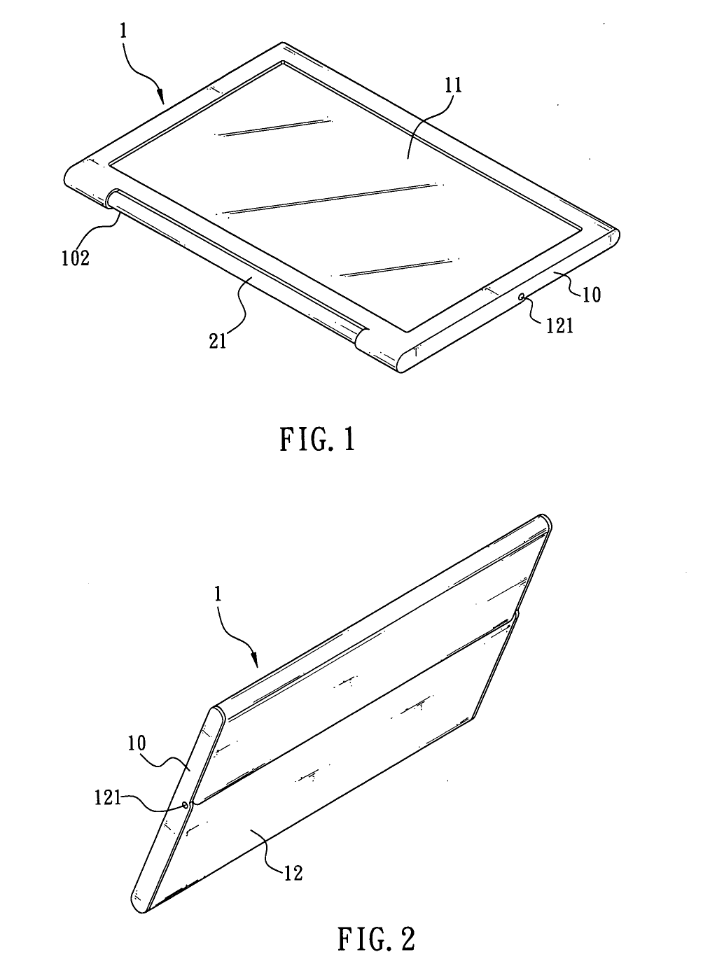

Referring to FIG. 1 and FIG. 2, the present invention has two different states under different application requirements and the tablet computer (1) comprises a main system (10), the front side of the main system (10) embeds a touch screen (11), users can input data through a pen or a finger (not shown in figure) by touching the touch screen (11); a back cover (12) with two pivots (121) on one side is disposed at a position of two-third of the backside of the main system (10), the back cover (12) takes the two pivots (121) as axes to turn outward to a proper angle with the main system (10) to form a standing support, users can obtain the best viewing angle of the touch screen (11). As shown in FIG. 2, the two pivots (121) of the back cover (12) are located on the two-third of the back of the main system (10), however this is not the only way for this application, the back cover (12) can be installed on any other proper location on the other side of the main system (10).

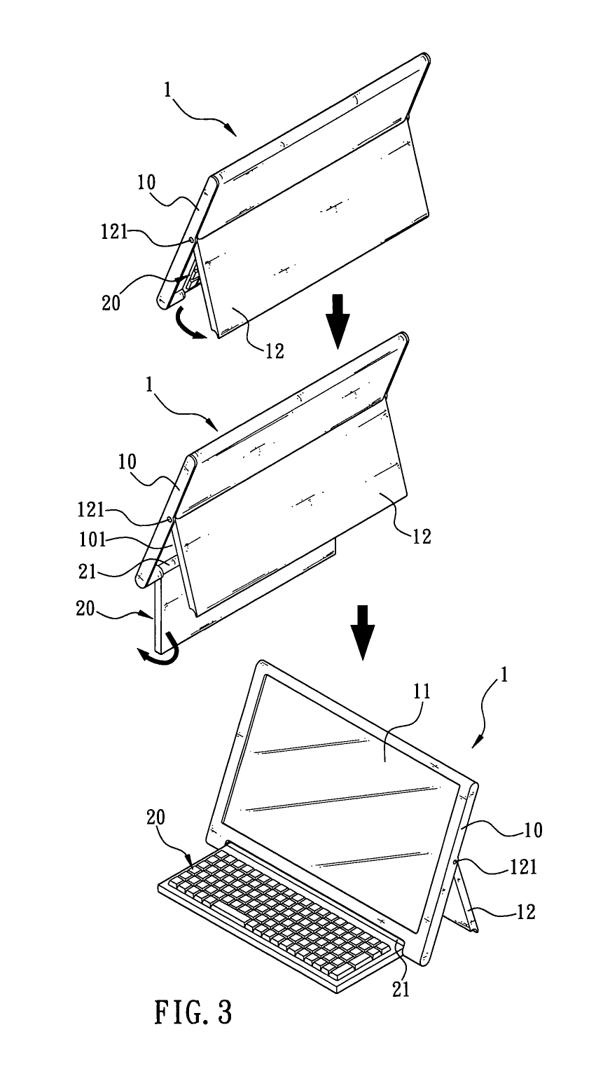

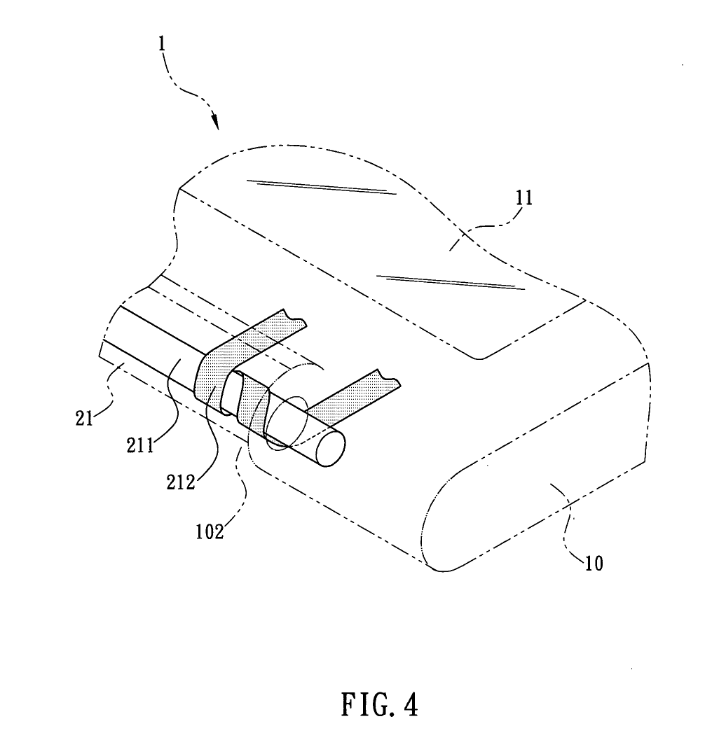

FIG. 3 and FIG. 4 show another embodiment of the present invention, and the back cover (12) uses the two pivots (121) as the rotary axis to turn outward for a proper angle, a container (101) is formed on the other side of the main system (10), the container (101) can store a hidden keyboard (20), a hinge (21) is located on the hidden keyboard (20) proximate the open back cover (12), and the hinge (21) as shown in FIG. 4 is used to connect the hidden keyboard (20) to the indentation slot (102) of the main system (10), the hinge (21) connects the hidden keyboard (20) to the two sides of the indentation slot (102) of the main system (10) through two sides of a pivotal axis (211), at least one communication line (212) in spiral shape passes through the pivotal axis (211), one end of the communication line (212) connects to the main system (10), the other end of the communication line (212) connects to the hidden keyboard (20) to let the hidden keyboard (20), main system (10) and the touch screen (11) communicate with each other.

In the above application as shown in FIG. 2, the back cover (12) uses the two pivots (121) as the rotary axis to turn outward for a proper angle with the main system (10) as the standing support, users can obtain the best viewing angle for the touch screen (11); please refer to FIG. 3 at the same time, users can adjust the hidden keyboard (20) by taking the hinge (21) as an rotary axis, and turn it outward to the same side with the touch screen (11) until they are in a horizontally balanced position.

The major feature of the present invention is to adopt the design concept of applying many different axes, and the back cover (12) with the two pivots (121) form the container (101) to store a hidden keyboard (20) when the back cover (12) is closed; they also form a stand for the main system (10) to stand vertically, such that the back cover (12) acts as a supporting stand; while the hidden keyboard (20) can be turned outward through two ends of the pivot axis (211) of the hinge (21) till they are in a horizontally balanced position. The present invention is a breakthrough of applications.

In the foregoing application as shown in FIG. 4, the communication line (212) could be a soft flat cable; the soft, bendable property makes the communication line (212) easy to be wrapped onto the pivotal axis (211). Mylar could be coated on the surface of the communication line (212) to increase the tenacity of the communication line (212).

Based on above description, the present invention has two different application states: the first state, as shown in FIG. 1 and FIG. 3, when users store the hidden keyboard (20) into the container (101) of the back cover (12) on the other side of the main system (10), they can control the tablet computer (1) through the touch screen (11), at the same time the tablet computer (1) is in a board shape which is easy to carry and store.

The second states, when the back cover (12) is turned outward, as shown in FIG. 3, the hidden keyboard (20) is turned to the direction of the touch screen (11) through the pivotal axis (211) of the hinge (21), the back cover (12) can be a supporting stand for the touch screen (11) to sustain the tablet computer (1) stand straight for users to input data with the hidden keyboard (20).

While a preferred embodiment of the invention has been shown and described in detail, it will be readily understood and appreciated that numerous omissions, changes and additions may be made without departing from the spirit and scope of the invention.

1. A lift-back tablet computer, comprising:
a main system, having a touch screen embedded at its front side for inputting data through a pen or a finger by touching said touch screen;
a back cover, having two pivots on one side at a position on the two-third of the back side of said main system, and said back cover using said two pivots as rotary axis to turn outward for a proper angle with said main system to form a standing support and provide a best viewing angle of said touch screen;
a hidden keyboard, said back cover taking the two pivots as rotary axis to turn outward for a proper angle, a hinge being located on said hidden keyboard side near the opening of said back cover, the connection of said hinge being connected to the indentation slot of said main system for adjusting said hidden keyboard by taking said hinge as an rotary axis to turn outward to the same side with said touch screen until said hidden keyboard being in a horizontally balanced position, such that said hidden keyboard being stored into said container of said back cover on the other side of said main system, and the tablet computer being in a board shape.

2. The lift-back tablet computer as recited in claim 1, wherein said hidden keyboard and main system is connected such that said hinge connects to the indentation slot of said main system, and to the two sides of said indentation slot through two sides of said pivot axis, and at least one communication line in spiral shape passes through said pivot axis, one end of said communication line connects to said main system, the other end of said communication line connects to said hidden keyboard to let said hidden keyboard, said main system and said touch screen communicate with each other.

3. The lift-back tablet computer as recited in claim 2, wherein said communication line is a soft flat cable; the soft, bendable property allows said communication line to be wrapped easily on said pivot axis.

4. The lift-back tablet computer as recited in claim 2, wherein said communication line has a Mylar coating on the surface to increase the tenacity of said communication line.

5. The lift-back tablet computer as recited in claim 1, wherein said hidden keyboard is stored in a container formed on the other side of said main system.

6. The lift-back tablet computer as recited in claim 1, wherein said back cover with two said pivots is located on one side of the two-third of the backside of said main system.
